(19) United States
(12) Patent Application Publication
(10) Pub. No.: US 2009/0277837 A1
(43) Pub. Date: Nov. 12, 2009

(54) Fluoropolymer Coated Membranes

(76) Inventors: Chunqing Liu, Schaumburg, IL (US); Man-Wing Tang, Cerritos, CA (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/115,726

(22) Filed: May 6, 2008

(51) Int. Cl. B01D 71/32; B05D 3/00; B01D 53/22; B01D 61/00; B01D 67/00

(52) U.S. Cl. 210/650; 210/500.28; 210/500.3; 95/45; 427/244; 210/490; 210/500.31; 210/500.32; 210/500.29; 210/500.27

(57) ABSTRACT

The present invention discloses fluoropolymer coated membranes and methods for making and using these membranes. The fluoropolymer coated membranes described in the current invention are prepared by coating a porous asymmetric membrane layer with a thin layer of fluoropolymer coating. The porous asymmetric membrane layer comprises an asymmetric cellulosic membrane, an asymmetric polymer membrane, or an asymmetric molecular sieve/polymer mixed matrix membrane with a low selectivity and high permeance. The fluoropolymer coating improves the selectivity of the porous asymmetric membrane layer and maintains the membrane performance with time. The fluoropolymer coated membranes are suitable for a variety of liquid, gas, and vapor separations such as desalination of water by reverse osmosis, non-aqueous liquid separation such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

### BACKGROUND OF THE INVENTION

Membrane-based technologies have advantages of both low capital cost and high-energy efficiency compared to conventional separation methods. Polymeric membranes have proven to operate successfully in industrial gas separations such as in the separation of nitrogen from air and the separation of carbon dioxide from natural gas. Cellulose acetate (CA) is a polymer currently being used in commercial gas separation. For example, UOP LLC's Separex™ CA membrane is used extensively for carbon dioxide removal from natural gas. Nevertheless, while they have experienced commercial success, CA membranes still need improvement in a number of properties including selectivity, performance durability, chemical stability, resistance to hydrocarbon contaminants, resistance to solvent swelling, and resistance to CO₂ plasticization. Natural gas often contains substantial amounts of heavy hydrocarbons and water, either as an entrained liquid, or in vapor form, which may lead to condensation within membrane modules. The gas separation capabilities of CA membranes are affected by contact with liquids including hydrocarbons and water. The presence of more than modest levels of hydrogen sulfide, especially in conjunction with water and heavy hydrocarbons, is also potentially damaging. Therefore, precautions must be taken to remove the entrained liquid water and heavy hydrocarbons upstream of the membrane separation steps. Another issue of CA polymer membranes that still needs to be addressed for their use in gas separations is the plasticization of the polymer by condensable gases such as carbon dioxide and propylene that leads to swelling of the membrane as well as a significant increase in the permeability of all components in the feed and a decrease in the selectivity of CA membranes. For example, the permeation behavior of CO₂ in CA membranes is different when compared to some other glassy polymers in that above a certain pressure level, the permeability coefficient begins to increase with pressure due to the onset of plasticization by the CO₂. A high concentration of sorbed CO₂ leads to increased segmental motion, and, consequently, the transport rate of the penetrant is enhanced. The challenge of treating gas, such as natural gas, that contains relatively large amounts of CO₂, such as more than about 10%, is particularly difficult.

Polymeric membrane materials have been found to be of use in gas separations. Numerous research articles and patents describe polymeric membrane materials (e.g., polyimides, polysulfones, polycarbonates, polyethers, polyamides, polyarylates, polypyrrolones) with desirable gas separation properties, particularly for use in oxygen/nitrogen separation (see, for example, U.S. Pat. No. 6,932,589). The polymeric membrane materials are typically used in processes in which a feed gas mixture contacts the upstream side of the membrane, resulting in a permeate mixture on the downstream side of the membrane with a greater mole fraction of one of the components than the composition of the original feed gas mixture. A pressure differential is maintained between the upstream and downstream sides, providing the driving force for permeation. The downstream side can be maintained as a vacuum, or at any pressure below the upstream pressure.

The membrane performance is characterized by the flux of a gas component across the membrane. This flux can be expressed as a quantity called the permeability (P), which is a pressure- and thickness-normalized flux of a given component. The separation of a gas mixture is achieved by a membrane material that permits a faster permeation rate for one component (i.e., higher permeability) over that of another component. The efficiency of the membrane in enriching a component over another component in the permeate stream can be expressed as a quantity called selectivity. Selectivity can be defined as the ratio of the permeabilities of the gas components across the membrane (i.e., P_{A}/P_{B}, where A and B are the two components). A membrane's permeability and selectivity are material properties of the membrane material itself, and thus these properties are ideally constant with feed pressure, flow rate and other process conditions. However, permeability and selectivity are both temperature-dependent. It is desired to develop membrane materials with a high selectivity (efficiency) for the desired component, while maintaining a high permeability (productivity) for the desired component.

The relative ability of a membrane to achieve the desired separation is referred to as the separation factor or selectivity for the given mixture. There are however several other obstacles to use of a particular polymer to achieve a particular separation under any sort of large scale or commercial conditions. One such obstacle is permeation rate or flux. One of the components to be separated must have a sufficiently high permeation rate at the preferred conditions or extraordinarily large membrane surface areas are required to allow separation of large amounts of material. Therefore, commercially available polymer membranes, such as CA, polyimide, and polysulfone membranes formed by phase inversion and solvent exchange methods have an asymmetric membrane structure. See U.S. Pat. No. 3,133,132. Such membranes are characterized by a thin, dense, selectively semipermeable surface “skin” and a less dense void-containing (or porous), non-selective support region, with pore sizes ranging from large in the support region to very small proximate to the “skin”. Such membranes have a serious shortcoming in that, in operation, the permeation rate and/or selectivity is reduced to unacceptable levels over time. This can occur for several reasons. One reason for the decrease of permeation rate has been attributed to a collapse of some of the pores near the skinned surface of the membrane, resulting in an undue densification of the surface skin. One attempt at overcoming this problem has been the development of thin film composite (or TFC) membranes, comprising a thin selective skin deposited on a resilient porous support. See, for example, “Thin-Film Composite Membrane for Single-Stage Seawater Desalination by Reverse Osmosis” by R. L. Riley et al., Applied Polymer Symposium No. 22, pages 255-267 (1973). TFC membranes can be formed from CA, polysulfone, polyethersulfone, polyamide, polyimide, polyetherimide, cellulose nitrate, polyurethane, polycarbonate, polystyrene, etc. While TFC membranes are less susceptible to flux decline than phase inversion-type membranes, fabrication of TFC membranes that are free from leaks is difficult, and fabrication requires multiple steps and so is generally more complex and costly. Another reason for the reduced permeation rate and/or selectivity over time is that impurities present in the mixture can over time clog the pores, if present, or interstitial spaces in the polymer. Yet another reason is that one or more components of the mixture can alter the form or structure of the polymer membrane over time thus changing its permeation rate and/or selectivity. One specific way this can happen is if one or more components of the mixture cause plasticization of the polymer membrane. Plasticization occurs when one or more of the components of the mixture act as a solvent in the polymer often causing it to swell and lose its membrane properties. It has been found that polymers such as cellulose acetate and polyimides which have particularly good separation factors for separation of mixtures comprising carbon dioxide and methane are prone to plasticization over time thus resulting in decreasing performance of these membranes.

One approach to overcoming the problem of leaks in asymmetric membranes has been the fabrication of an asymmetric gas separation membrane comprising a relatively porous and substantial void-containing selective “parent” membrane such as polysulfone or cellulose acetate that would have selectivity were it not porous, wherein the parent membrane is coated with a material such as a polysiloxane, a silicone rubber, or a UV-curable epoxysilicone in occluding contact with the porous parent membrane, the coating filling surface pores and other imperfections comprising voids (see U.S. Pat. No. 4,230,463; U.S. Pat. No. 4,877,528; U.S. Pat. No. 6,368,382). The coating of such coated membranes comprising siloxane or silicone segments, however, is subject to swelling by solvents, poor performance durability, low resistance to hydrocarbon contaminants, and low resistance to plasticization by the sorbed penetrant molecules such as CO₂ or C₃H₆.

Therefore, an asymmetric membrane post-treatment is needed which improves selectivity but does not change or damage the membrane, or cause the membrane to lose performance with time. In addition, gas separation membranes desirably have a high permeation rate to gases. This means that the effective portion of the membrane should be as thin as possible. Therefore, the coating layer on the top surface of the relatively porous and substantial void-containing selective “parent” asymmetric membrane needs to be thin and the materials used as the coating layer should have high permeation rate or flux.

The present invention overcomes some of the problems of the prior art membranes by providing a fluoropolymer coated asymmetric polymer membrane such as cellulosic membrane or an asymmetric molecular sieve/polymer mixed matrix membrane and a route to making said membrane that has the following properties/advantages: low cost, high selectivity and permeation rate or flux, and stable flux and sustained selectivity over time by resistance to solvent swelling, plasticization and hydrocarbon contaminants.

### SUMMARY OF THE INVENTION

This invention pertains to novel fluoropolymer coated membranes comprising a thin layer of fluoropolymer coating on top of a porous asymmetric membrane layer and methods for making and using these membranes.

The fluoropolymer coated membrane described in the current invention comprises a porous asymmetric membrane layer which is directly coated with a thin layer of fluoropolymer coating that provides improved selectivity and stable performance over a wider range of temperature, in the presence of high concentration of CO₂ and/or in the presence of hydrocarbon contaminants. The porous asymmetric membrane layer with a low selectivity and high flux can be made from materials including cellulosic membranes, membranes formed from other polymers such as polysulfone, polyethersulfone, polyamide, polyimide, polyetherimide, cellulose nitrate, polyurethane, polycarbonate, polystyrene, polybenzoxazole, etc, as well as membranes formed from molecular sieve/polymer mixed matrix materials such as AIPO-14/polyimide mixed matrix material and AIPO-14/(polyimide+polyethersulfone) mixed matrix material. The fluoropolymer coating improves the selectivity of the porous asymmetric membrane layer and exhibits essentially no loss in selectivity or no loss in flux rates over a typical operating period. The term “essentially no loss in flux rates” means that the flux declines less than about 30%, and more particularly the flux rate declines less than 20% over a typical operating period.

The present invention provides a method for the production of a fluid separation membrane comprising directly coating a porous asymmetric membrane layer, such as cellulose acetate, with a dilute solution of the fluoropolymer dissolved in a perfluorinated organic solvent to uniformly disperse the fluoropolymer over the porous asymmetric membrane layer, evaporating the perfluorinated organic solvent to obtain a thin fluoropolymer coating on the porous asymmetric membrane layer. The method to form the porous asymmetric membrane layer comprises casting a porous asymmetric membrane layer using a membrane casting solution (or called casting dope), and then drying the porous asymmetric membrane layer. The membrane casting solution comprises a polymer membrane casting solution such as a polymer dissolved in a mixture of organic solvents or two or more blend polymers dissolved in a mixture of organic solvents, or a mixed matrix membrane casting solution comprising molecular sieves such as AIPO-14 dispersed in one or two polymers dissolved in a mixture of organic solvents.

The invention provides a process for separating at least one gas from a mixture of gases using the fluoropolymer coated membranes described in the present invention, the process comprising: (a) providing a fluoropolymer coated membrane which is permeable to said at least one gas; (b) contacting the mixture on one side of the fluoropolymer coated membrane to cause said at least one gas to permeate the fluoropolymer coated membrane; and (c) removing from the opposite side of the membrane a permeate gas composition comprising a portion of said at least one gas which permeated said membrane.

The fluoropolymer coated membranes of the present invention are suitable for a variety of liquid, gas, and vapor separations such as desalination of water by reverse osmosis, non-aqueous liquid separation such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffms separations, and other light gas mixture separations

### DETAILED DESCRIPTION OF THE INVENTION

The use of membranes for separation of both gases and liquids is a growing technological area with potentially high economic reward due to the low energy requirements and the potential for scaling up of modular membrane designs. Advances in membrane technology, with the continuing development of new membrane materials will make this technology even more competitive with traditional, high-energy intensive and costly processes such as distillation. Among the applications for large scale gas separation membrane systems are nitrogen enrichment, oxygen enrichment, hydrogen recovery, removal of hydrogen sulfide and carbon dioxide from natural gas and dehydration of air and natural gas. Also, various hydrocarbon separations are potential applications for the appropriate membrane system. The materials that are used in these applications must have high selectivity, durability, and productivity in processing large volumes of gas or liquid in order to be economically successful. Membranes for gas separations have evolved rapidly in the past 25 years due to their easy processability for scale-up and low energy requirements. More than 90% of the membrane gas separation applications involve the separation of noncondensable gases: such as carbon dioxide from methane, nitrogen from air, and hydrogen from nitrogen, argon or methane. Membrane gas separation is of special interest to petroleum producers and refiners, chemical companies, and industrial gas suppliers. Several applications of membrane gas separation have achieved commercial success, including carbon dioxide removal from natural gas and biogas and in enhanced oil recovery.

The membranes most commonly used in commercial gas separation applications are asymmetric polymeric membranes characterized by a thin, dense, selectively semipermeable surface “skin” and a less dense porous, void-containing, non-selective support region. Gas separation by these membranes is based on a solution-diffusion mechanism. This mechanism involves molecular-scale interactions of the permeating gas with the membrane polymer. This mechanism assumes that each component is sorbed by the membrane at one interface, transported by diffusion across the membrane through the voids between the polymeric chains (or called free volume), and desorbed at the other interface. According to the solution-diffusion model, the membrane performance for a given pair of gases (e.g., CO₂/CH₄, O₂/N₂, H₂/CH₄) is determined by two parameters: permeability coefficient (P_{A}) and the selectivity (α_{A/B}). The P_{A} is the product of the gas flux and the membrane “skin” thickness, divided by the pressure difference across the membrane. The α_{A/B} is the ratio of the permeability coefficients of the two gases (α_{A/B}=P_{A}/P_{B}) where P_{A} is the permeability of the more permeable gas and P_{B} is the permeability of the less permeable gas. Gases can have high permeability coefficient because of a high solubility coefficient, a high diffusion coefficient, or both. The diffusion coefficient decreases and the solubility coefficient increases with the increase in the molecular size of the gas. For high-performance polymer membranes, both high permeability and selectivity are desirable because higher permeability decreases the size of the membrane area required to treat a given amount of gas, thereby decreasing the capital cost of membrane units, and because higher selectivity results in a higher purity product gas with increased efficiency.

Cellulose acetate (CA) glassy polymer membranes have been used extensively in gas separations. Nevertheless, while they have experienced commercial success, CA membranes still need improvement in a number of properties including selectivity, performance durability, chemical stability, resistance to hydrocarbon contaminants, resistance to solvent swelling, and resistance to CO₂ plasticization. Natural gas often contains substantial amounts of heavy hydrocarbons and water, either as an entrained liquid, or in vapor form, which may lead to condensation within membrane modules. The gas separation capabilities of CA membranes are affected by contact with liquids including hydrocarbons and water. The presence of more than modest levels of hydrogen sulfide, especially in conjunction with water and heavy hydrocarbons, is also potentially damaging. Therefore, precautions must be taken to remove the entrained liquid water and heavy hydrocarbons upstream of the membrane separation steps. Another issue of CA polymer membranes that still needs to be addressed for their use in gas separations is the plasticization of the polymer by condensable gases such as carbon dioxide and propylene that leads to swelling of the membrane as well as a significant increase in the permeability of all components in the feed and a decrease in the selectivity of CA membranes.

Asymmetric polymeric membranes can be formed by phase inversion followed by direct air drying through the use of at least one drying agent which is a hydrophobic organic compound such as a hydrocarbon or an ether (see U.S. Pat. No. 4,855,048). Asymmetric polymeric membranes can also be formed by phase inversion followed by solvent exchange methods (see U.S. Pat. No. 3,133,132). Another method to prepare asymmetric polymeric membrane is to coat the porous asymmetric polymeric membrane formed by phase inversion followed by direct air drying or solvent exchange methods with a thin layer of material such as a polysiloxane, a silicone rubber, or a UV-curable epoxysilicone. The coating filling the surface pores and other imperfections comprising voids (see U.S. Pat. No. 4,230,463; U.S. Pat. No. 4,877,528; U.S. Pat. No. 6,368,382). The coating of such coated membranes comprising siloxane or silicone segments, however, is subject to swelling by solvents, poor performance durability, low resistance to hydrocarbon contaminants, and low resistance to plasticization by the sorbed penetrant molecules such as CO₂ or C₃H₆.

This invention relates to novel fluoropolymer coated membranes comprising a thin layer of fluoropolymer coating on top of a porous asymmetric membrane layer. More specifically, this invention relates to a method for making these novel fluoropolymer coated membranes. This invention also pertains to the application of these fluoropolymer coated membranes not only for a variety of gas separations such as separations of CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases separations, but also for liquid separations such as desalination and pervaporation.

The fluoropolymer coated membrane described in the current invention comprises a porous asymmetric membrane layer which is directly coated with a thin layer of fluoropolymer coating that provides improved selectivity and stable performance over a wider range of temperature, in the presence of high concentration of CO₂ and/or in the presence of hydrocarbon contaminants. The porous and asymmetric membrane substrate with a low selectivity and high flux can be formed by phase inversion followed by direct air drying through the use of at least one drying agent which is a hydrophobic organic compound such as a hydrocarbon or an ether. The porous and asymmetric membrane substrate with a low selectivity and high flux can also be formed by phase inversion followed by solvent exchange methods (see U.S. Pat. No. 3,133,132). The fluoropolymer coating improves the selectivity of the porous asymmetric membrane layer and exhibits essentially no loss in selectivity or no loss in flux rates over a typical operating period. The term “essentially no loss in flux rates” means that the flux declines less than about 30%, and more particularly the flux rate declines less than 20% over a typical operating period.

Selection of the porous asymmetric membrane layer for the present invention may be made on the basis of the heat resistance, solvent resistance, and mechanical strength of the porous asymmetric membrane layer, as well as other factors dictated by the operating conditions for selective permeation, as long as the fluoropolymer coating and the porous asymmetric membrane layer have the prerequisite relative separation factors in accordance with the invention for at least one pair of gases or liquids. The porous asymmetric membrane layer is preferably at least partially self-supporting, and in some instances may be essentially self-supporting. The porous asymmetric membrane layer may provide essentially all of the structural support for the membrane, or the fluoropolymer coated membrane may include a structural support member which can provide little, if any, resistance to the passage of gases or liquids.

Generally, the porous asymmetric membrane layer described in the present invention is prepared from cellulosic polymers, other polymers such as polysulfone, polyethersulfone, polyimide, etc, as well as molecular sieve/polymer mixed matrix materials such as AIPO-14/polyimide mixed matrix material and AIPO-14/(polyimide+polyethersulfone) mixed matrix material. The polymers used for the preparation of the porous asymmetric membrane layer described in the present invention provide a range of properties such as low cost, high permeability, good mechanical stability, and ease of processability that are important for gas and liquid separations. Typical polymers suitable for the preparation of the porous asymmetric membrane layer according to the present invention can be substituted or unsubstituted polymers and may be selected from but is not limited to, polysulfones; sulfonated polysulfones; polyethersulfones (PESs); sulfonated PESs; polyethers; polyetherimides such as Ultem (or Ultem 1000) sold under the trademark Ultem®, manufactured by GE Plastics; poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyratc, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole)s; polybenzoxazoles; polyhydrazides; polyoxadiazoles; polytriazoles; poly(benzimidazole)s; polycarbodiimides; polyphosphazines; microporous polymers; and interpolymers, including block interpolymers containing repeating units from the above such as interpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers that are suitable for the preparation of the porous asymmetric membrane layer according to the present invention include, but are not limited to, polysulfones, sulfonated polysulfones, polyethersulfones (PESs), sulfonated PESs, polyethers, polyetherimides such as Ultem (or Ultem 1000) sold under the trademark Ultem®, manufactured by GE Plastics, and available from GE polymerland, cellulosic polymers such as cellulose acetate and cellulose triacetate, polyamides, polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediaminel (poly(6FDA-m-PDA)), poly[2,2′-bis-(3,4-dicarboxyphenyl)hexafluoropropane dianhydride-1,3-phenylenediamine-3,5-diaminobenzoic acid](poly(6FDA-m-PDA-DABA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), polyamide/imides, polyketones, polyether ketones, and polymers of intrinsic microporosity.

The most preferred polymers that are suitable for the preparation of the porous asymmetric membrane layer according to the present invention include, but are not limited to, polyimides such as Matrimid®, P84®, poly(BTDA-PMDA-TMMDA), poly(BTDA-PMDA-ODPA-TMMDA), poly(DSDA-TMMDA), poly(BTDA-TMMDA), and poly(DSDA-PMDA-TMMDA), polyetherimides such as Ultem®, polyethersulfones, polysulfones, cellulose acetate, cellulose triacetate, and poly(vinyl alcohol)s.

The porous asymmetric membrane layer described in the present invention can also be prepared from molecular sieve/polymer mixed matrix materials. The term “molecular sieve/polymer mixed matrix material” as used in this invention means that the material comprises a continuous polymer matrix and molecular sieve particles uniformly dispersed throughout the continuous polymer matrix. The continuous polymer matrix in the molecular sieve/polymer mixed matrix material described in the present invention can be selected from any of the polymers that are suitable for the preparation of the porous asymmetric membrane layer according to the present invention. The molecular sieves in the molecular sieve/polymer mixed matrix material described in the present invention can be selected from microporous and mesoporous molecular sieves, carbon molecular sieves, and porous metal-organic frameworks (MOFs).

Molecular sieves in the molecular sieve/polymer mixed matrix material described in the present invention improve the separation performance of the polymer material by including selective holes/pores with a size that permits a gas such as carbon dioxide to pass through, but either does not permit another gas such as methane to pass through, or permits it to pass through at a significantly slower rate. Microporous molecular sieve materials are microporous crystals with pores of a well-defined size ranging from about 0.2 to 2 nm. This discrete porosity provides molecular sieving properties to these materials which have found wide applications as catalysts and sorption media. Some preferred microporous molecular sieves used in the current invention include SAPO-34, Si-DDR, UZM-9, AIPO-14, AIPO-53, AIPO-34, AIPO-17, SSZ-62, SSZ-13, AIPO-18, UZM-5, UZM-25, ERS-12, CDS-1, MCM-65, ZSM-52, MCM-47, 4A, AIPO-34, SAPO-44, SAPO-47, SAPO-17, CVX-7, SAPO-35, SAPO-56, AIPO-52, SAPO-43, silicalite-1, NaX, NaY, and CaY. Mesoporous molecular sieves are porous inorganic or organic-inorganic hybrid materials with a pore size ranging from 2 nm to 50 nm. Examples of preferred mesoporous molecular sieves used in the current invention include MCM-41. SBA-15, and surface functionalized MCM-41 and SBA-15. etc. MOFs can also be used as the molecular sieves in the molecular sieve/polymer mixed matrix material described in the present invention. MOFs are a new type of highly porous crystalline zeolite-like materials and are composed of rigid organic units assembled by metal-ligands. They possess vast accessible surface areas per unit mass. See Yaghi et al., SCIENCE, 295: 469 (2002); Yaghi et al., MICROPOR. MESOPOR. MATER., 73: 3 (2004); Dybtsev et al., ANGEW. CHEM. INT. ED., 43: 5033 (2004). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. See Yaghi et al., 123: 4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of the polyimide membranes due to relatively larger pore sizes than those of zeolite materials. MOF, IR-MOF and MOP materials are also expected to allow the polymer to infiltrate the pores, which would improve the interfacial and mechanical properties and would in turn affect permeability. Therefore, these MOF, IR-MOF and MOP materials (all termed “MOF” herein this invention) are used as molecular sieves in the molecular sieve/polymer mixed matrix material for the preparation of porous “parent” asymmetric mixed matrix membrane substrate in the present invention.

The solvents used for dissolving the polymer material for the preparation of porous “parent” asymmetric membrane substrate are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of porous “parent” asymmetric membrane substrate, such as N-methylpyrrolidone (NMP) and N,N-dimethyl acetamide (DMAc), methylene chloride, tetrahydrofuran (THF), acetone, isopropanol, octane, methanol, ethanol, N,N-dimethylformamide (DMF), dimethyl sulfoxide (DMSO), toluene, dioxanes, 1,3-dioxolane, mixtures thereof, others known to those skilled in the art and mixtures thereof.

U.S. Pat. No. 6,368,382 by Chiou claimed a method of making an epoxysilicone coated membrane by coating a porous asymmetric membrane layer with a UV-curable controlled release epoxysilicone coating. A mixture of the epoxysilicone resin and an onium photocatalyst are applied to the porous asymmetric membrane layer and cured by UV or electron beam radiation to produce a dry epoxysilicone coated membrane. The coating of such coated membranes comprising siloxane or silicone segments, however, is subject to swelling by solvents, poor performance durability, low resistance to hydrocarbon contaminants, and low resistance to plasticization by the sorbed penetrant molecules such as CO₂ or C₃H₆.

The present invention employs a fluoropolymer as the thin coating on the surface of the porous asymmetric membrane layer to form a novel fluoropolymer coated membrane. The fluoropolymer coated membrane may be flat sheet or hollow fiber. The fluoropolymers have high thermal, chemical, mechanical, and electrical stability; high gas permeability and selectivity. The fluoropolymer coating provides the porous asymmetric membrane layer improved selectivity and stable performance over a wider range of temperature and in the presence of high concentration of CO₂ and/or in the presence of hydrocarbon contaminants. The fluoropolymer coated membrane exhibits essentially no loss in selectivity or no loss in flux rates with time. The fluoropolymer described in the present invention has high penneability (or flux) and hydrophobic property. The fluoropolymer used as the coating in the fluoropolymer coated membrane in this invention is selected from any type of fluoro-based polymers such as DuPont™ Teflon® AF family of amorphous fluoropolymers including Teflon® AF1600 and Teflon® AF2400, FluoroPel™ PFC 504A CoE5 and FluoroPel™ PFC 504A CoFS fluoropolymers from Cytonix Corporation. DuPont's Teflon AF fluoropolymers that are useful include a fluoropolymer that is a homopolymer of 2,2-bistrifluoro-methyl-4,5-difluoro-1,3-dioxole (PDD), and a fluoropolymer that is an amorphous copolymer of 2,2-bistrifluoro-methyl-4,5-difluoro-1,3-dioxole (PDD) with a complementary amount of another fluorine-containing monomer selected from the group consisting of tetrafluoroethylene (TFE), perfluoro(alkyl vinyl ether)s, hexafluoropropylene, vinylidene fluoride, and chlorotrifluoroethylene. Other fluoropolymers from DuPont that are effective include a fluoropolymer that is an amorphous copolymer of 2,2-bistrifluoro-methyl-4,5-difluoro-1,3-dioxole (PDD) and tetrafluoroethylene (TFE), a fluoropolymer that is an amorphous copolymer of 2,2-bistrifluoro-methyl-4,5-difluoro-1,3-dioxole (PDD) and tetrafluoroethylene (TFE) with 65 mol-% of dioxole and a glass transition temperature of is 160° C. (this is available commercially as DuPont Teflon® AF1600) and a fluoropolymer that is an amorphous copolymer of 2,2-bistrifluoro-methyl-4,5-difluoro-1,3-dioxole (PDD) and tetrafluoroethylene (TFE) with 87 mol-% of dioxole and a glass transition temperature of 240° C. (this is available as DuPont Teflon AF2400).

Another source of useful fluoropolymers is Solvay Solexis's Hyflon AD fluoropolymers: Including a fluoropolymer that is a copolymer of 2,2,4-trifluoro-5-trifluoromethoxy-1,3-dioxole (TTD) and tetrafluoroethylene (TFE) and a fluoropolymer that is a copolymer of 2,2,4-trifluoro-5-trifluoromethoxy-1,3-dioxole (TTD) and tetrafluoroethylene (TFE) with 80 mol-% of TTD and 20 mol-% of TFE.

Cytonix Corporation's fluoropolymers include a fluoropolymer that is a fluoro-silane fluorinated copolymer with silane functional groups and a fluoropolymer that is a fluoro-epoxide fluorinated oligomer with epoxide functional groups.

The solvents that can be used for dissolving the fluoropolymer are essentially perfluorinated solvents and mixtures thereof such as Fluorinert FC-75 (perfluoro(n-butyltetrahydrofuran)), and Fluorinert FC-72, Fluorinert FC-40 (perfluoro(alkyl amine)). It is preferred that the fluoropolymer be diluted in the perfluorinated organic solvent or mixtures thereof in a concentration of from about 1 to about 20 wt-% to provide an effective coating. The dilute fluoropolymer solution is applied to the surface of the porous asymmetric membrane layer by dip-coating, spin coating, casting, spraying, painting, and other known conventional solution coating technologies. A thin fluoropolymer coating on the porous asymmetric membrane layer is formed after evaporating the perfluorinated organic solvent(s).

The present invention provides a method for the production of a fluid separation membrane comprising directly coating a porous asymmetric membrane layer, such as cellulose acetate, with a dilute solution of the fluoropolymer dissolved in a perfluorinated organic solvent to uniformly disperse the fluoropolymer over the porous asymmetric membrane layer, evaporating the perfluorinated organic solvent to obtain a thin fluoropolymer coating on the porous asymmetric membrane layer. The method to form the porous asymmetric membrane layer comprises casting a porous asymmetric membrane layer using a membrane casting solution (or called casting dope), and then drying the porous asymmetric membrane layer through a direct air drying method (see U.S. Pat. No. 4,855,048) or through a solvent exchange method (see U.S. Pat. No. 3,133,132) to form a dry porous asymmetric membrane. The membrane casting solution comprises a polymer membrane casting solution such as a polymer dissolved in a mixture of organic solvents or two or more blend polymers dissolved in a mixture of organic solvents, or a mixed matrix membrane casting solution comprising molecular sieves dispersed in one or two polymers dissolved in a mixture of organic solvents.

For example, the porous asymmetric membrane layer can be a thin porous cellulosic asymmetric membrane having a skin thickness of less than about 10,000 angstroms. Preferably, the thin porous cellulosic asymmetric membrane has a skin thickness between about 200 and about 1000 angstroms, and more preferably, the thin porous cellulosic asymmetric membrane has a skin thickness between about 300 and about 500 angstroms. The membrane performance for a given pair of gases (e.g., CO₂/CH₄, O₂/N₂, H₂/CH₄) is determined by two parameters: permeability coefficient (or called permeability, PA) and the selectivity (α_{A/B}). Generally, in order to separate one gaseous component from another, the ratio of the permeability of the more permeable component to the other component, which is the selectivity of the more permeable component over the other component should be at least five. The term “porous cellulosic asymmetric membrane” in the context of the current invention includes cellulose ester membranes such as cellulose acetate, cellulose diacetate, cellulose triacetate, cellulose propionate, cellulose butyrate, cellulose cyanoethylate, cellulose methacrylate and mixtures thereof. A particularly preferred membrane comprises cellulose acetate or/and cellulose triacetate. The porous cellulosic membrane layer can be made to any degree of initial porosity as characterized by its initial selectivity, which may range from 0.5 to about 8. The porous cellulosic membrane layer of the present invention is porous and is characterized as having an initial selectivity of less than about 8, and more preferably having a selectivity less than about 5, and most preferably having a selectivity less than about 3. The concentration of the fluoropolymer content in the dilute solvent is dependent upon the initial porosity of the porous cellulosic membrane layer to provide a stable fluoropolymer coated membrane.

The invention provides a process for separating at least one gas from a mixture of gases using the fluoropolymer coated membranes described in the present invention, the process comprising: (a) providing a fluoropolymer coated membrane which is permeable to said at least one gas; (b) contacting the mixture on one side of the fluoropolymer coated membrane to cause said at least one gas to permeate the fluoropolymer coated membrane; and (c) removing from the opposite side of the membrane a permeate gas composition comprising a portion of said at least one gas which permeated said membrane.

The fluoropolymer coated membranes of the present invention are especially useful in the purification, separation or adsorption of a particular species in the liquid or gas phase. In addition to separation of pairs of gases, these fluoropolymer coated membranes may, for example, be used for the desalination of water by reverse osmosis or for the separation of proteins or other thermally unstable compounds, e.g. in the pharmaceutical and biotechnology industries. The fluoropolymer coated membranes may also be used in fermenters and bioreactors to transport gases into the reaction vessel and transfer cell culture medium out of the vessel. Additionally, the fluoropolymer coated membranes may be used for the removal of microorganisms from air or water streams, water purification, ethanol production in a continuous fermentation/membrane pervaporation system, and in detection or removal of trace compounds or metal salts in air or water streams.

The fluoropolymer coated membranes of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffm separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the fluoropolymer coated membranes described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases. When permeable components are acid components selected from the group consisting of carbon dioxide, hydrogen sulfide, and mixtures thereof and are removed from a hydrocarbon mixture such as natural gas, one module, or at least two in parallel service, or a series of modules may be utilized to remove the acid components. For example, when one module is utilized, the pressure of the feed gas may vary from 275 kPa to about 2.6 MPa (25 to 4000 psi). The differential pressure across the membrane can be as low Is as about 0.7 bar or as high as 145 bar (about 10 psi or as high as about 2100 psi) depending on many factors such as the particular membrane used, the flow rate of the inlet stream and the availability of a compressor to compress the permeate stream if such compression is desired. Differential pressure greater than about 145 bar (2100 psi) may rupture the membrane. A differential pressure of at least 7 bar (100 psi) is preferred since lower differential pressures may require more modules, more time and compression of intermediate product streams. The operating temperature of the process may vary depending upon the temperature of the feed stream and upon ambient temperature conditions. Preferably, the effective operating temperature of the membranes of the present invention will range from about −50° to about 100° C. More preferably, the effective operating temperature of the membranes of the present invention will range from about −20° to about 70° C., and most preferably, the effective operating temperature of the membranes of the present invention will be less than about 70° C. Some membranes such as plastics, resins, and mixed matrix membranes exhibit better permeability characteristics at higher temperatures; however, in the preferred embodiment, a cellulose acetate membrane is utilized.

The fluoropolymer coated membranes described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these fluoropolymer coated membranes may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The fluoropolymer coated membranes may incorporate a species that adsorbs strongly to certain gases (e.g. cobalt porphyrins or phthalocyanines for O₂ or silver(I) for ethane) to facilitate their transport across the membrane.

These fluoropolymer coated membranes may also be used in the separation of liquid mixtures by pervaporation, such as in the removal of organic compounds (e.g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these fluoropolymer coated membranes is the deep desulfurization of gasoline and diesel fuels by a pervaporation membrane process similar to the process described in U.S. Pat. No. 7,048,846, incorporated by reference herein in its entirety. The fluoropolymer coated membranes that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol butylacetate, butanol-1-butylether, ethanol-ethylbutylether, propylacetate-propanol, isopropylether-isopropanol, methanol-ethanol-isopropanol, and ethylacetate-ethanol-acetic acid.

The fluoropolymer coated membranes may be used for separation of organic molecules from water (e.g. ethanol and/or phenol from water by pervaporation) and removal of metal and other organic compounds from water.

An additional application of the fluoropolymer coated membranes is in chemical reactors to enhance the yield of equilibrium-limited reactions by selective removal of a specific product in an analogous fashion to the use of hydrophilic membranes to enhance esterification yield by the removal of water.

The fluoropolymer coated membranes described in the current invention have immediate applications for the separation of gas mixtures including carbon dioxide removal from natural gas. The fluoropolymer coated membrane permits carbon dioxide to diffuse through at a faster rate than the methane in the natural gas. Carbon dioxide has a higher permeation rate than methane because of higher solubility, higher diffusivity, or both. Thus, carbon dioxide enriches on the permeate side of the membrane, and methane enriches on the feed (or reject) side of the membrane.

Any given pair of gases that differ in size, for example, nitrogen and oxygen, carbon dioxide and methane, carbon dioxide and nitrogen, hydrogen and methane or carbon monoxide, helium and methane, can be separated using the fluoropolymer coated membranes described herein. More than two gases can be removed from a third gas. For example, some of the components which can be selectively removed from a raw natural gas using the membranes described herein include carbon dioxide, oxygen, nitrogen, water vapor, hydrogen sulfide, helium, and other trace gases. Some of the components that can be selectively retained include hydrocarbon gases.

### EXAMPLES

The following examples are provided to illustrate one or more preferred embodiments of the invention, but are not limited embodiments thereof. Numerous variations can be made to the following examples that lie within the scope of the invention.

### Example 1

Preparation of Porous Cellulose Acetate Asymmetric Membrane (Abbreviated as “Porous CA”)

A relatively porous cellulose acetate asymmetric membrane having a CO₂/CH₄ selectivity of about 6.24 was prepared in a conventional manner from a casting dope comprising, by approximate weight percentages, 8% cellulose triacetate, 8% cellulose diacetate, 47% dioxane, 20% acetone, 12% methanol, 2.4% lactic acid, 3.1% n-decane. A film was cast on a polyester fabric then gelled by immersion in a 2° C. water bath for about 10 minutes, and then annealed in a hot water bath at 80° to 90° C. for about 15 minutes. The resulting wet membrane was dried in air at a drying temperature between about 60° and 70° C. to remove water to form the dry porous asymmetric cellulosic membrane (porous CA).

### Example 2

Preparation of FluoroPel™ PFC 504A CoE5 Fluoropolymer Coated Cellulose Acetate Asymmetric Membrane (Abbreviated as “PFC-CA”)

The porous CA membrane (porous CA) prepared in Example 1 was then coated with a dilute fluoropolymer solution containing about 4 wt-% FluoroPel™ PFC 504A CoE5 fluoropolymer from Cytonix Corporation by a dip coating method. The fluoropolymer coated cellulosic membrane was dried at room temperature for 0.5 hour and then dried at 85° C. oven for 2 hours to evaporate the perfluorinated organic solvent to obtain a thin fluoropolymer coating on the porous CA asymmetric membrane (PFC-CA).

### Example 3

CO₂/CH₄ Separation Performance of Porous CA and PFC-CA Membranes

A 76 mm (3 inch) diameter circle of the porous CA substrate membrane of Example 1 and a 76 mm (3 inch) diameter circle of the PFC-CA membrane of Example 2 were evaluated for gas transport properties using pure CO₂ and pure CH₄ feed gases at a feed pressure of about 690 kPa (100 psig). Table 1 shows a comparison of the CO₂ permeance (P_{CO2}/L) and the selectivity (α_{CO2/CH4}) of the porous CA and PFC-CA membranes of the present invention.

TABLE 1
Pure gas permeation test results of Porous CA and
PFC-CA for CO₂/CH₄ separation

| Membrane | P_{CO2}/L (A.U.)^{b} | α_{CO2/CH4} |
|---|---|---|
| rous CA^{a} | 17.4 | 6.24 |
| PFC-CA^{a} | 3.28 | 22.6 |

^{a}Tested at 25° C. under 690 kPa (100 psig) pure gas pressure.
^{b}1 A.U. = 4.42 × 10⁻⁴ m³ (STP)/m² · h · kPa.

The Porous CA substrate membrane of Example 1 and PFC-CA membrane of Example 2 were also evaluated for CO₂/CH₄ separation performance under 6900 kPa (1000 psig) high pressure mixed feed gas (10 vol-% CO₂ in CH₄ feed gas) testing conditions. The results in Table 2 show that the PFC-CA membrane showed much higher CO₂/CH₄ selectivity than the Porous CA substrate membrane.

TABLE 2
Mixed gas permeation test results of Porous CA
and PFC-CA for CO₂/CH₄ separation

| Membrane | P_{CO2}/L (A.U.)^{b} | α_{CO2/CH4} |
|---|---|---|
| Porous CA^{a} | 15.5 | 4.58 |
| PFC-CA^{a} | 8.3 | 13.0 |

^{a}Tested at 50° C. under 6900 kPa (1000 psig) mixed gas pressure with 10% CO₂ in CH₄.
^{b}1 A.U. = 4.42 × 10⁻⁴ m³ (STP)/m² · h · kPa.

### Example 4

Preparation of Teflon® AF1600 Fluoropolymer Coated Cellulose Acetate Asymmetric Membrane (Abbreviated as “6% AF1600-CA”)

The porous CA membrane (porous CA) prepared in Example 1 was then coated with a dilute fluoropolymer solution containing about 6 wt-% Teflon® AF1600 fluoropolymer from DuPont by a dip coating method. The fluoropolymer coated cellulosic membrane was dried at room temperature for 0.5 hour and then dried at 85° C. oven for 2 hours to evaporate the perfluorinated organic solvent to obtain a thin fluoropolymer coating on the porous CA asymmetric membrane (6% AF1600-CA).

### Example 5

Preparation of “Control” RTV Silicone-Coated Cellulose Acetate Asymmetric Membrane (Abbreviated as “Silicone-CA”)

The porous CA membrane (porous CA) prepared in Example 1 was coated with a dilute RTV silicone solution containing about 10 wt-% RTV silicone (9 wt-% RTV615A silicone and 1 wt-% RTV615B obtained from GE Silicones in hexane solvent). The RTV silicone-coated CA membrane was dried at ambient temperature for 0.5 hour to evaporate the solvent. Then the membrane was heated at 85° C. in an oven for 2 hours to cross-link the RTV Silicone to obtain a thin RTV silicone coating on the porous CA asymmetric membrane (Silicone-CA).

### Example 6

Comparison of Adsorption Properties of Silicone-CA, PFC-CA, and 6% AF1600-CA Membranes for n-Hexane Contaminant

The adsorption properties of the Silicone-CA, PFC-CA, and 6% AF1600-CA membranes for n-hexane contaminant were studied at 25° C. using a low pressure volumetric adsorption isotherm device. The results found were that both PFC-CA and 6% AF1600-CA membranes have much higher tolerance to n-hexane contaminant than the Silicone-CA membrane.

### Example 7

Preparation of Teflon® AF2400 Fluoropolymer Coated Cellulose Acetate Asymmetric Membrane (Abbreviated as “1% AF2400-CA”)

The porous CA membrane (porous CA) prepared in Example 1 was coated with a dilute fluoropolymer solution containing about 1 wt-% Teflon® AF2400 fluoropolymer from DuPont. The fluoropolymer coated cellulosic membrane was dried at room temperature for 0.5 hour and then dried at 85° C. oven for 2 hours to evaporate the perfluorinated organic solvent to obtain a thin fluoropolymer coating on the porous CA asymmetric membrane (1% AF2400-CA).

### Example 8

CO₂/CH₄ separation performance of porous CA and 1% AF2400-CA membranes

A 76 mm (3 inch) diameter circle of the porous CA substrate membrane of Example 1 and a 76 mm (3 inch) diameter circle of the 1% AF2400-CA membrane of Example 7 were evaluated for CO₂/CH₄ separation performance under 6900 kPa (1000 psig) high pressure mixed feed gas (10 vol-% CO₂ in C₄ feed gas) testing conditions. The results in Table 3 show that the 1% AF2400-CA membrane showed much higher CO₂/CH₄ selectivity than the Porous CA substrate membrane.

TABLE 3
Mixed gas permeation test results of Porous CA and
PFC-CA for CO₂/CH₄ separation

| Membrane | P_{CO2}/L(A.U.)^{b} | α_{CO2/CH4} |
|---|---|---|
| Porous CA^{a} | 15.5 | 4.58 |
| 1% AF2400-CA^{a} | 10.0 | 12.9 |

^{a}Tested at 50° C. under 6900 kPa (1000 psig) mixed gas pressure with 10% CO₂ in CH₄.
^{b}1 A.U. = 4.42 × 10⁻⁴ m³ (STP)/m² · h · kPa.

1. A method for making a fluid separation fluoropolymer coated membrane comprising: (a) casting or spinning a porous asymmetric membrane layer; (b) drying the porous asymmetric membrane layer through a direct air drying method or a solvent exchange method to form a dry porous asymmetric membrane; (c) directly coating the dry porous asymmetric membrane with a dilute solution of a fluoropolymer dissolved in a perfluorinated organic solvent to uniformly disperse the fluoropolymer over the dry porous asymmetric membrane; and (d) evaporating the perfluorinated organic solvent to obtain the fluid separation fluoropolymer coated membrane having a thin coating of said fluoropolymer on the dry porous asymmetric membrane layer.

2. The method of claim 1 wherein said fluoropolymer is selected from the group consisting of 2,2-bistrifluoro-methyl-4,5-difluoro-1,3-dioxole (PDD); an amorphous copolymer of 2,2-bistrifluoro-methyl-4,5-difluoro-1,3-dioxole (PDD) and another fluorine-containing monomer selected from the group consisting of tetrafluoroethylene (TFE), perfluoro(alkyl vinyl ether)s, hexafluoropropylene, vinylidene fluoride, and chlorotrifluoroethylene; an amorphous copolymer of 2,2-bistrifluoro-methyl-4,5-difluoro-1,3-dioxole (PDD) and tetrafluoroethylene (TFE); a copolymer of 2,2,4-trifluoro-5-trifluoromethoxy-1,3-dioxole (TTD) and tetrafluoroethylene (TFE); a fluoro-silane fluorinated copolymer with silane functional groups and a fluoro-epoxide fluorinated oligomer with epoxide functional groups.

3. The method of claim 2 wherein said fluoropolymer is selected from the group consisting of an amorphous copolymer of about 87 mol-% 2,2-bistrifluoro-methyl-4,5-difluoro-1,3-dioxole (PDD) and 13 mol-% tetrafluoroethylene (TFE); and a fluoro-epoxide fluorinated oligomer with epoxide functional groups.

4. The method of claim 1 wherein said perfluorinated organic solvent is selected from the group consisting of perfluoro(n-butyltetrahydrofuran) and perfluoro(alkyl amine).

5. The method of claim 1 wherein said porous asymmetric membrane layer comprises a polymer selected from the group consisting of cellulose acetate, cellulose diacetate, cellulose triacetate, cellulose propionate, cellulose butyrate, cellulose cyanoethylate, cellulose methacrylate, and mixtures thereof.

6. The method of claim 1 wherein said porous asymmetric membrane layer comprises a polymer selected from the group consisting of polysulfone, sulfonated polysulfone, polyethersulfone, sulfonated polyethersulfone, polyimide, polyetherimide, polyamide, polyurethane, polycarbonate, polystyrene, polybenzoxazole, polyamide/imide, polyketone, polyether ketone, polyether ether ketone, polymer of intrinsic microporosity, and mixtures thereof.

7. The method of claim 1 wherein said porous asymmetric membrane layer comprises a mixture of at least one polymer and molecular sieves.

8. The method of claim 7 wherein said polymer is selected from the group consisting of polysulfones, sulfonated polysulfones, polyethersulfones, sulfonated polyethersulfones, polyethers, polyetherimides, cellulosic polymers selected from the group consisting of cellulose acetate and cellulose triacetate, polyamides; polyimides, poly(3,3′,4,4′-benzophenone tetracarboxylic diaihydride-pyromellitic diaiihydride-3,3′,5,5′-tetramethyl-4,4′-methylene dianiline) (poly(BTDA-PMDA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl) hexafluoropropane dianhydride-1,3-phenylenediamine](poly(6FDA-m-PDA)), poly[2,2′-bis-(3,4-dicarboxyphenyl)hexafluoropropane dianhydride-1,3-phenylenediamine-3,5-diaminobenzoic acid)](poly(6FDA-m-PDA-DABA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)); polyamide/imides; polyketones, polyether ketones; and polymers of intrinsic microporosity.

9. The method of claim 7 wherein said at least one polymer is selected from the group consisting of polyimides selected from the group consisting of poly(BTDA-PMDA-TMMDA), poly(BTDA-PMDA-ODPA-TMMDA), poly(DSDA-TMMDA), poly(BTDA-TMMDA), and poly(DSDA-PMDA-TMMDA), polyetherimides, polyethersulfones, polysulfones, cellulose acetate, cellulose triacetate, and poly(vinyl alcohol)s.

10. The method of claim 7 wherein said molecular sieves are selected from the group consisting of SAPO-34, Si-DDR, UZM-9, AIPO-14, AIPO-53, AIPO-34, AIPO-17, SSZ-62, SSZ-13, AIPO-18, UZM-5, UZM-25, ERS-12, CDS-1, MCM-65, ZSM-52, MCM-47, 4A, AIPO-34, SAPO-44, SAPO-47, SAPO-17, CVX-7, SAPO-35, SAPO-56, AIPO-52, SAPO-43, silicalite-1, NaX, NaY, and CaY.

11. The method of claim 1 wherein said porous asymmetric membrane layer comprises a skin thickness less than about 1000 angstroms.

12. The method of claim 1 wherein said porous asymmetric membrane layer exhibits a selectivity less than about 8.

13. A process for separating at least one liquid or gas from a mixture of liquids or a mixture of gases using the fluoropolymer coated membranes of claim 1, wherein the process comprises (a) providing said fluoropolymer coated membrane, wherein said fluoropolymer coated membrane is permeable to said at least one gas or one liquid; (b) contacting the mixture of gases or liquids on one side of the fluoropolymer coated membrane to cause said at least one gas or one liquid to permeate the fluoropolymer coated membrane; and (c) removing from an opposite side of the fluoropolymer coated membrane a permeate gas composition or a permeate liquid composition comprising a portion of said at least one gas or one liquid that permeated said fluoropolymer coated membrane.

14. The process of claim 13 wherein said mixture of gases is selected from the group consisting of nitrogen and oxygen, carbon dioxide and methane, carbon dioxide and nitrogen, hydrogen and methane or carbon monoxide, helium and methane.

15. The process of claim 13 wherein said mixture of gases or liquids comprises two or more gases or liquids selected from the group consisting of ethylacetate and ethanol, diethylether and ethanol, acetic acid and ethanol, benzene and ethanol, chloroform and ethanol, chloroform and methanol, acetone and isopropylether, allylalcohol and allylether, allylalcohol and cyclohexane, butanol and butylacetate, butanol and 1-butylether, ethanol and ethylbutylether, propylacetate and propanol, isopropylether and isopropanol, methanol and ethanol and isopropanol, and ethylacetate and ethanol and acetic acid.

16. A fluid separation fluoropolymer coated membrane comprising a thin coating of a fluoropolymer on a porous asymmetric membrane layer.

17. The fluid separation membrane of claim 16 wherein said fluoropolymer is selected from the group consisting of 2,2-bistrifluoro-methyl-4,5-difluoro-1,3-dioxole (PDD); an amorphous copolymer of 2,2-bistrifluoro-methyl-4,5-difluoro-1,3-dioxole (PDD) and another fluorine-containing monomer selected from the group consisting of tetrafluoroethylene (TFE), perfluoro(alkyl vinyl ether)s, hexafluoropropylene, vinylidene fluoride, and chlorotrifluoroethylene; an amorphous copolymer of 2,2-bistrifluoro-methyl-4,5-difluoro-1,3-dioxole (PDD) and tetrafluoroethylene (TFE); a copolymer of 2,2,4-trifluoro-5-trifluoromethoxy-1,3-dioxole (TTD) and tetrafluoroethylene (TFE); a fluoro-silane fluorinated copolymer with silane functional groups and a fluoro-epoxide fluorinated oligomer with epoxide functional groups.

18. The fluid separation membrane of claim 16 wherein said porous asymmetric membrane layer comprises a polymer selected from the group consisting of cellulose acetate, cellulose diacetate, cellulose triacetate, cellulose propionate, cellulose butyrate, cellulose cyanoethylate, cellulose methacrylate, and mixtures thereof.

19. The fluid separation membrane of claim 16 wherein said porous asymmetric membrane layer comprises a polymer selected from the group consisting of polysulfone, sulfonated polysulfone, polyethersulfone, sulfonated polyethersulfone, polyimide, polyetherimide, polyamide, polyurethane, polycarbonate, polystyrene, polybenzoxazole, polyamide/imide, polyketone, polyether ketone, polyether ether ketone, polymer of intrinsic microporosity, and mixtures thereof.

20. The fluid separation membrane of claim 16 wherein said porous asymmetric membrane layer comprises a mixture of at least one polymer and at least one type of molecular sieve.

21. The fluid separation membrane of claim 20 wherein said polymer is selected from the group consisting of polysulfones, sulfonated polysulfones, polyethersulfones, sulfonated polyethersulfones, polyethers, polyetherimides, cellulosic polymers selected from the group consisting of cellulose acetate and cellulose triacetate, polyamides; polyimides, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine](poly(6FDA-m-PDA)), poly[2,2′-bis-(3,4-dicarboxyphenyl)hexafluoropropane dianhydride-1,3-phenylenediamine-3,5-diaminobenzoic acid)](poly(6FDA-m-PDA-DABA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)); polyamide/imides; polyketones, polyether ketones; and polymers of intrinsic microporosity.

22. The fluid separation membrane of claim 20 wherein said at least one polymer is selected from the group consisting of polyimides selected from the group consisting of poly(BTDA-PMDA-TMMDA), poly(BTDA-PMDA-ODPA-TMMDA), poly(DSDA-TMMDA), poly(BTDA-TMMDA), and poly(DSDA-PMDA-TMMDA), polyetherimides, polyethersulfones, polysulfones, cellulose acetate, cellulose triacetate, and poly(vinyl alcohol)s.

23. The fluid separation membrane of claim 20 wherein said molecular sieves are selected from the group consisting of SAPO-34, Si-DDR, UZM-9, AIPO-14, AIPO-53, AIPO-34, AIPO-17, SSZ-62, SSZ-13, AIPO-18, UZM-5, UZM-25, ERS-12, CDS-1, MCM-65, ZSM-52, MCM-47, 4A, AIPO-34, SAPO-44, SAPO-47, SAPO-17, CVX-7, SAPO-35, SAPO-56, AIPO-52, SAPO-43, silicalite-1, NaX, NaY, and CaY.

24. The fluid separation membrane of claim 16 wherein said porous asymmetric membrane layer comprises a skin thickness less than about 1000 angstroms.

25. The fluid separation membrane of claim 16 wherein said porous asymmetric membrane layer exhibits a selectivity less than about 8.

26. The fluid separation membrane of claim 16 wherein said fluid separation membrane is used for desalination of water by reverse osmosis, organic/aqueous liquid separation, organic/organic separation, pervaporation, or for separation of gaseous mixtures into their constituent parts.
